(19) United States
(12) Patent Application Publication
(10) Pub. No.: US 2025/0156340 A1
(43) Pub. Date: May 15, 2025

(54) TECHNIQUES FOR REDUCING SECURITY RISKS WHEN IMPLEMENTING REMOTE DIRECT MEMORY ACCESS THROUGH A PROXY NODE

(71) Applicant: NVIDIA CORPORATION, Santa Clara, CA (US)

(72) Inventors: Chris J. NEWBURN, South Beloit, IL (US); Eliav BAR-ILAN, Or Akiva (IL); Oren DUER, Kohav Yair (IL); Gal SHALOM, Santa Clara, CA (US); Vishwanath VENKATESAN, Austin, TX (US); Aviad YEHEZKEL, Santa Clara, CA (US); Yorey ZACK, Santa Clara, CA (US); Kiran Kumar MODUKURI, San Ramon, CA (US)

(21) Appl. No.: 18/943,141

(22) Filed: Nov. 11, 2024

Related U.S. Application Data
(60) Provisional application No. 63/548,181, filed on Nov. 11, 2023.

(51) Int. Cl. G06F 12/14; G06F 15/173

(52) U.S. Cl. CPC G06F 12/1475; G06F 15/17331; G06F 2212/1052

(57) ABSTRACT

In various embodiments, a memory key service is used to remotely access one or more portions of a physical memory included in a host node. The memory key service generates a first memory key that maps a host address space from a first protection domain associated with the host node to a second protection domain associated with a proxy node. The memory key service generates a second memory key based on the first memory key and a first address range associated with the host node. The memory key service transmits the second memory key to a software component executing on the proxy node. The software component causes a shared storage system to access a first portion of the physical memory based on the second memory key.

### CROSS-REFERENCE TO RELATED APPLICATIONS

This application claims priority benefit of the United States Provisional Patent Application titled, “KEY SERVICE FOR SECURE STORAGE IN THE DATA CENTER,” filed on Nov. 11, 2023, and having Ser. No. 63/548,181. The subject matter of this related application is hereby incorporated herein by reference.

### BACKGROUND

### Field of the Various Embodiments

The various embodiments relate generally to computer systems and computer network security and, more specifically, to techniques for reducing security risks when implementing remote direct memory access through a proxy node.

### Description of the Related Art

A typical data center includes networked computer servers that collectively provide storage, processing, and networking resources to one or more clients. In some data centers, storage resources are hard partitioned, and the data associated with a given client is strictly segregated (e.g., via different databases) from the data associated with other clients. However, the amount of storage required by different clients over time can fluctuate substantially. As a general matter, providing sufficient segregated storage to meet the fluctuating storage requirements of all clients at all times would require a prohibitively large amount of infrastructure and storage resources. Consequently, many data centers share storage resources across different clients.

One approach to sharing storage resources across different clients involves implementing one or more shared storage systems within a data center. Each shared storage system includes storage (e.g., one or more disks) as well as one or more file servers and can be accessed by multiple different host nodes. In operation, a given file server included within a shared storage system performs various operations, such as read and write operations, on the storage included within the shared storage system in response to requests received from operating systems executing on the multiple different host nodes. After performing the operations specified in a given request, the file server transmits a response back to the operating system that transmitted the request.

One drawback of implementing shared storage systems in data centers is that the security measures for data centers oftentimes are implemented on the different host nodes accessing the data centers. The host nodes are vulnerable to various types of on-line attacks that can compromise those security measures. Once the security measures are compromised, the operating systems executing on the host nodes can be used maliciously to read, modify, and/or delete the data associated with any number of different host nodes stored in the shared storage systems implemented within a data center.

One approach to reducing security risks when accessing shared storage is configuring the host nodes such that the host nodes access shared storage indirectly via data processing units (DPUs), where the DPUs are configured to be less vulnerable to on-line security attacks than the host nodes. In this regard, the DPUs are configured such that the DPUs are not directly controlled by the operating systems or other software executing on the host nodes. Consequently, to the extent malware or other nefarious types of software infect a given host node, the malware or nefarious software is less able to circumvent security mechanisms and/or operational restrictions implemented by the DPU associated with that host node.

Once the DPUs are set up, to process a host request for transferring data between a host buffer residing on a host node and a location within the shared storage system, the host node forwards the host request to the corresponding DPU. The DPU copies any input data from the host buffer to a proxy buffer residing on the DPU. The DPU converts the host request to a proxy request for transferring data between the proxy buffer and the same location within the shared storage system. The DPU routes the proxy request to a file server included within the shared storage system. In response, the file server operates on the same location within the storage system to generate a proxy response and then transmits the proxy response to the DPU. In accordance with the proxy response, the DPU stores any output data in the proxy buffer. The DPU converts the proxy response to a host response and forwards the host response to the host node. Lastly, the host node copies any output data from the proxy buffer to the host buffer in accordance with the host response.

One drawback of using DPUs is that, because data is copied between a host buffer and a proxy buffer, indirectly accessing a shared storage system via a DPU is less efficient than directly accessing the shared storage system. In particular, storing and forwarding data through a proxy buffer can substantially increase latency and decrease throughput, thereby degrading overall data transfer performance. Furthermore, the overhead associated with executing these types of additional copy operations can increase the amount of processing resources required to transfer data between host nodes and the shared storage system, thereby decreasing the overall performance of the software applications executing on the host nodes.

As the foregoing illustrates, what is needed in the art are more effective techniques for accessing shared storage systems.

### SUMMARY

One embodiment sets forth a computer-implemented method for remotely accessing one or more portions of a physical memory included in a host node. The method includes generating a first memory key that maps a host address space from a first protection domain associated with the host node to a second protection domain associated with a proxy node; generating a second memory key based on the first memory key and a first address range associated with the host node; and transmitting the second memory key to a software component executing on the proxy node, where the software component causes a shared storage system to access a first portion of the physical memory based on the second memory key.

At least one technical advantage of the disclosed techniques relative to the prior art is that, with the disclosed techniques, a DPU can invoke remote direct memory access (RDMA) operations between a host node and a shared storage system. These RDMA operations enable a DPU to cause data to be transferred between host buffer(s) residing on the host node and location(s) within a shared storage system without using intermediate proxy buffers. Accordingly, with the disclosed techniques, data transfer latencies can be decreased and overall data throughput can be increased, which can improve data transfer performance relative to what can be achieved using prior art techniques. Furthermore, unlike prior art techniques, the disclosed techniques do not incur overhead associated with executing additional copy operations to and from proxy buffers. Accordingly, the amount of processing resources required to transfer data between host nodes and shared storage systems can be decreased, which can increase the overall performance of the software applications executing on host nodes relative to what can be achieved using prior art techniques. These technical advantages provide one or more technological improvements over prior art approaches.

In addition, to invoke RDMA operations between a host node and a shared storage system, a DPU has to expose the physical memory of the host node to the shared storage system. However, the disclosed techniques also enable a DPU to implement subordinate memory keys in order to reduce the security risks associated with exposing the physical memory of the host node. In that regard, when issuing an RDMA request to a shared storage system on behalf of a host node, the DPU is able to provide a subordinate memory key that is associated with a host buffer within the physical memory of the host node. The subordinate memory key exposes the host buffer to the shared storage system without exposing any other portion of the physical memory of the host node to the shared storage system. Notably, the use of subordinate memory keys can be implemented separately from or in combination with the use of DPUs to control data transfers between host nodes and shared storage systems. These additional technical advantages provide one or more additional technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the proxy application of FIG. 1, according to various embodiments;

FIG. 3A is a more detailed illustration of the memory key service of FIG. 1, according to various embodiments;

FIG. 3B is a conceptual illustration of protection domain mappings implemented by the memory key service of FIG. 3A, according to various embodiments;

FIGS. 4A-4B set forth a flow diagram of method steps for processing requests to access one or more locations within a shared storage system, according to various embodiments; and

FIG. 5 is a flow diagram of method steps for implementing subordinate memory keys that expose different subsets of a physical memory, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

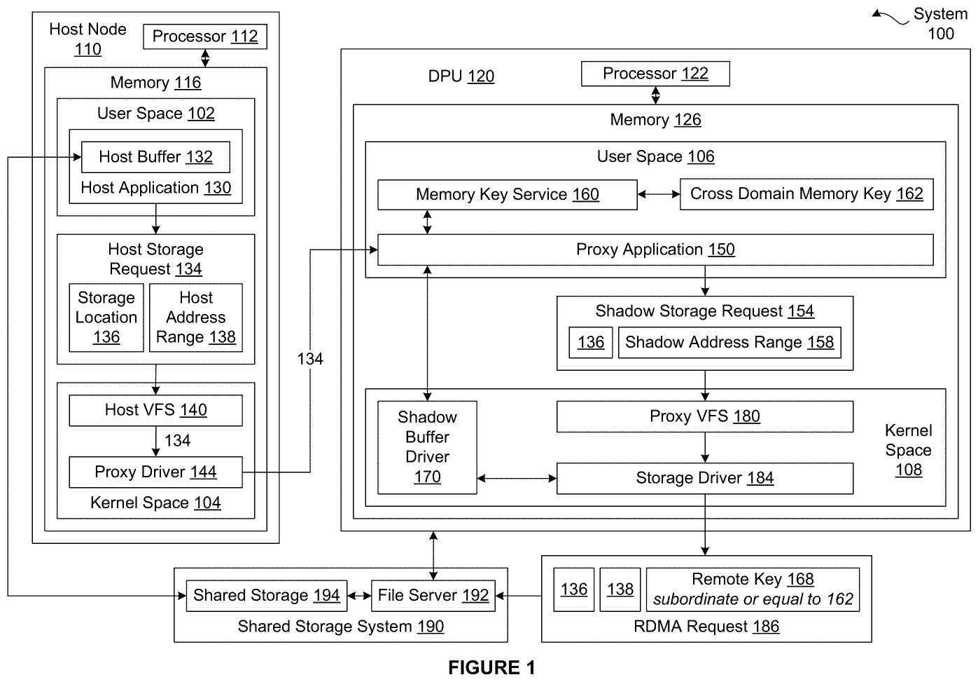

FIG. 1 is a conceptual illustration of a system 100 configured to implement one or more aspects of the various embodiments. As shown, in some embodiments, the system 100 includes, without limitation, a host node 110, a shared storage system 190, and a DPU 120. In some other embodiments, the system 100 can further include, without limitation, one or more other host nodes, one or more other DPUs, any number and/or types of other compute nodes, any number and/or types of other storage systems, or any combination thereof.

The components of the system 100 can be distributed across any number of shared geographic locations and/or any number of different geographic locations and/or implemented in one or more cloud computing environments (i.e., encapsulated shared resources, software, data, etc.) in any combination. In some embodiments, the system 100 is at least a portion of a data center.

The host node 110 and zero or more other host nodes are compute nodes that execute applications associated with different clients. In some embodiments, a compute node can be any type of device that includes, without limitation, at least one processor, at least one memory, and is not directly controlled by any other compute node. Each compute node can be implemented in a cloud computing environment, implemented as part of any other distributed computing environment, or implemented in a stand-alone fashion. Any number of compute nodes can provide a multiprocessing environment in any technically feasible fashion.

A processor of a compute node can be any instruction execution system, apparatus, or device capable of executing instructions. For example, a processor of a compute node could comprise a central processing unit (CPU), a graphics processing unit (GPU), a data processing unit (DPU), a controller, a micro-controller, a state machine, or any combination thereof. A memory of a compute node stores content, such as software applications and data, for use by at least one processor of the compute node. A memory of a compute node can be one or more of a readily available memory, such as random-access memory, read only memory, floppy disk, hard disk, or any other form of digital storage, local or remote.

In some embodiments, a storage (not shown) may supplement or replace one or more memories of a compute node. The storage of a compute node may include any number and type of external memories that are accessible to at least one processor of the compute node. For example, and without limitation, the storage can include a Secure Digital Card, an external Flash memory, a portable compact disc read-only memory, an optical storage device, a magnetic storage device, or any suitable combination of the foregoing.

In some embodiments, a storage (not shown) that is accessible to the processor of a compute node may supplement or replace the memory of a compute node. The storage may include any number and type of external memories that are accessible to the processor of the compute node. For example, and without limitation, the storage can include a Secure Digital Card, an external Flash memory, a portable compact disc read-only memory, an optical storage device, a magnetic storage device, or any suitable combination of the foregoing.

In general, each compute node is configured to implement one or more software applications. For explanatory purposes only, each software application is described as residing in the memory of a single compute node and executing on the processor of the same compute node. However, in some embodiments, the functionality of each software application can be distributed across any number of other software applications that reside in the memories of any number of compute nodes and execute on the processors of any number of compute nodes in any combination. Further, subsets of the functionality of multiple software applications can be consolidated into a single software application.

The shared storage system 190 can be any type of file system that is associated with any number and/or types of file servers and includes any amount and/or types of storage that is used to store data associated with multiple different clients. For instance, the shared storage system 190 can be a local file system, a remote file system, a cloud-based file system, any type of distributed file system (e.g., a parallel file system), or any combination thereof.

As shown, in some embodiments, the shared storage system 190 includes, without limitation, a file server 192 and shared storage 194. The file server 192 can be any type of server that is used to access the shared storage 194. In the same or other embodiments, the file server 192 is not included in the shared storage system 190 but is used to access the shared storage 194 in any technically feasible fashion (and therefore is associated with the shared storage system 190). The file server 192 can implement any number and/or types of network file sharing protocols (e.g., Network File System).

The shared storage 194 can include any number and/or types of persistent storage resources that can be shared across any number of different clients. For instance, in some embodiments, the shared storage 194 includes any amount (including none) of shared file storage, any amount (including none) of shared block storage, any amount (including none) of key value storage, and any amount (including none) of other types of storage (e.g., object storage). An example of a storage system that includes object storage is Amazon Simple Storage Service. In particular, the shared storage 194 is shared across at least a first client associated with the host node 110 and any number (including none) of other clients associated with any number of different host nodes.

As described previously herein, in one conventional approach to reducing security risks when sharing storage resources across different clients, host nodes access shared storage indirectly via data processing units (DPUs), where the DPUs are configured to be less vulnerable to on-line security attacks than the host nodes. Once the DPUs are set up, to process a host request for transferring data between a host buffer residing on a host node and a location within the shared storage system, the host node forwards the host request to the corresponding DPU. The DPU copies any input data from the host buffer to a proxy buffer residing on the DPU. The DPU converts the host request to a proxy request for transferring data between the proxy buffer and the same location within the shared storage system. The DPU routes the proxy request to a file server included within the shared storage system. In response, the file server operates on the same location within the storage system to generate a proxy response and then transmits the proxy response to the DPU. In accordance with the proxy response, the DPU stores any output data in the proxy buffer. The DPU converts the proxy response to a host response and forwards the host response to the host node. Lastly, the host node copies any output data from the proxy buffer to the host buffer in accordance with the host response.

One drawback of using DPUs as described above is that, storing and forwarding data through a proxy buffer can substantially increase latency and decrease throughput, thereby degrading overall data transfer performance. Furthermore, the overhead associated with executing these types of additional operations can increase the amount of processing resources required to transfer data between host nodes and the shared storage system, thereby decreasing the overall performance of the software applications executing on the host nodes.

### Invoking RDMA Operations Between Host Nodes and Shared Storage Systems Through DPUs

To address the above problems, in some embodiments, each of any number of DPUs is configured to invoke remote direct memory access (RDMA) operations between a corresponding host node and the shared storage system 190 on behalf of the corresponding host node. As persons skilled in the art will recognize, RDMA refers to a “zero-copy” networking technology that enables two networked components (e.g., host nodes, DPUs, shared storage systems) to transfer data without involving the processors and operating systems of the two networked components.

Advantageously, as described below, by invoking an RDMA transfer operation between a corresponding host node and a shared storage system, a DPU can cause data to be transferred between the host node and the shared storage system without using an intermediate proxy buffer. As a result, data transfer latencies can be decreased and overall data throughput can be increased relative to what can be achieved using prior art techniques.

For explanatory purposes, techniques for invoking RDMA operations between host nodes and shared storage systems through DPUs are described herein in the context of invoking RDMA data transfer operations between the host node 110 and the shared storage system 190 through the DPU 120 in accordance with a host storage request 134. As referred to herein “invoking” an RDMA data transfer operation between the host node 110 and the shared storage system 190 causes data to be transferred between shared storage system 190 to the host node 110 via RDMA in accordance with the host storage request 134 or any other host storage request.

The DPU 120 can be connected to the host node 110 and to the file server 192 included in the shared storage system 190 via any number and/or types of networks. In various embodiments depicted in and described in conjunction with FIGS. 1-4B the host node 110 is connected to the DPU 120 via Peripheral Component Interconnect Express (PCIe). The DPU 120 includes a direct memory access (DMA) engine that enables the DPU 120 to initiate DMA transfers between the host node 110 and the DPU 120. The host node 110, the DPU 120, and the file server 192 can implement any number and/or types of network file sharing protocols (e.g., Network File System). Although not shown, the DPU 120 and the file server 192 each include any amount and/or types of RDMA network interface hardware. For explanatory purposes, the RDMA network interface hardware included in the DPU 120 is also referred to herein as a “proxy RDMA interface.”

As persons skilled in the art will recognize, the techniques described herein are illustrative rather than restrictive and can be altered and applied in other contexts without departing from the broader spirit and scope of the inventive concepts described herein. For example, the use DPUs to control data transfers as described herein in conjunction with FIGS. 1-5 can be modified and applied to invoke any number and/or types of RDMA data transfer operations between a host node and any number and/or types of shared storage systems through and number and/or types of DPUs that are less vulnerable to on-line security threats than the host node.

As shown, the host node 110 includes, without limitation, a host application 130, a host virtual file system (VFS) 140, and a proxy driver 144. The host application 130 resides in a user space 102 within the memory 116 of the host node 110 and executes on the processor 112 of the host node 110. The host application 130 can issue any number and/or types of “host storage requests,” where each host storage request is a request associated with the shared storage system 190. More specifically, each host storage request is a request for one or more operations to be performed at one or more specified locations within the shared storage system 190.

In some embodiments, the processor 112 is a CPU, and a host storage request can be a Portable Operating System Interface (POSIX) compliant system call, a Network File System system call, any other type of system call, a call to a function included in a POSIX compliant application programming interface (API), or any other type of function call. In some other embodiments, the processor 112 is a GPU, the host application 130 executes on the GPU, and a host storage request can be a system call that is issued directly by the host application 130. In yet other embodiments, the host application 130 generates a host storage request based on an original request received from a function executing on a GPU that is included in or otherwise associated with the host node 110.

Some examples of types of operations that can be requested via a host storage request include a connection operation, a mount operation, a file write operation, a file read operation, a file open operation, a file close operation, a file creation operation, a file deletion operation, a directory listing operation, a directory creation operation, and a directory deletion operation. A host storage request can specify one or more locations within the shared storage system 190 in any technically feasible fashion. For instance, a host storage request can specify an Internet Protocol (IP) address of the file server 192, a path name of a file within the shared storage 194, a file handle for an opened file within the shared storage 194, a path name for a directory within the shared storage 194, or any combination thereof.

The host application 130 can allocate any number and/or types of host buffers for storage of data (e.g., data to be written to or read from the shared storage system 190) associated with any number and/or types of host storage requests in any technically feasible fashion. Each host buffer corresponds to a different address range within an address space associated with the host node 110 and a different portion of physical memory of the host node 110. In various embodiments, any number of host buffers can be allocated for potential storage communication. In the same or other embodiments, any portions of any number of host buffers can be allocated for read access and/or for write access. In some embodiments, any number of host buffers can be allocated during a lifetime of a data transfer.

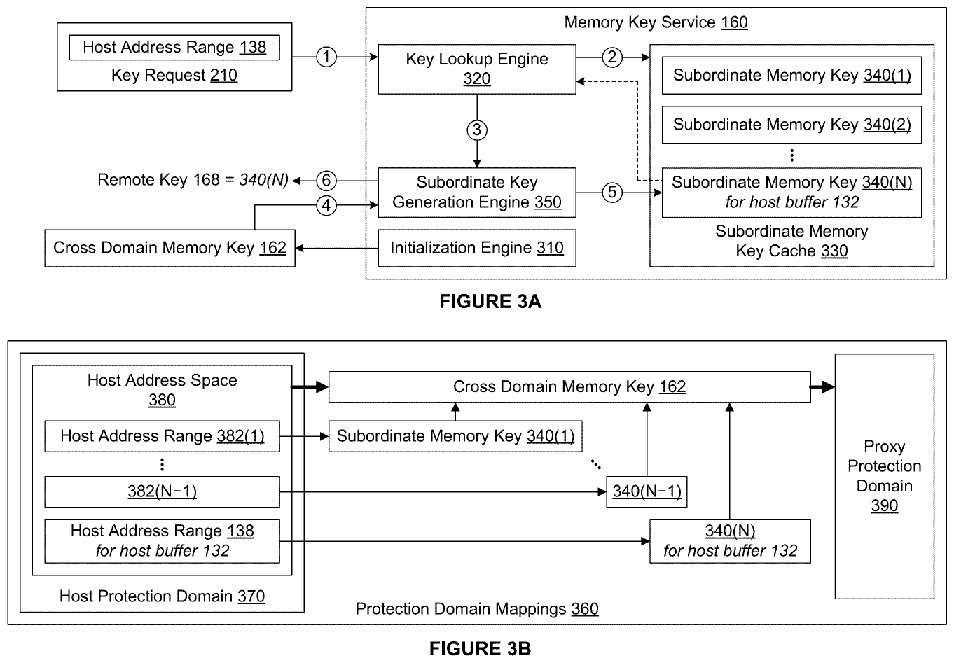

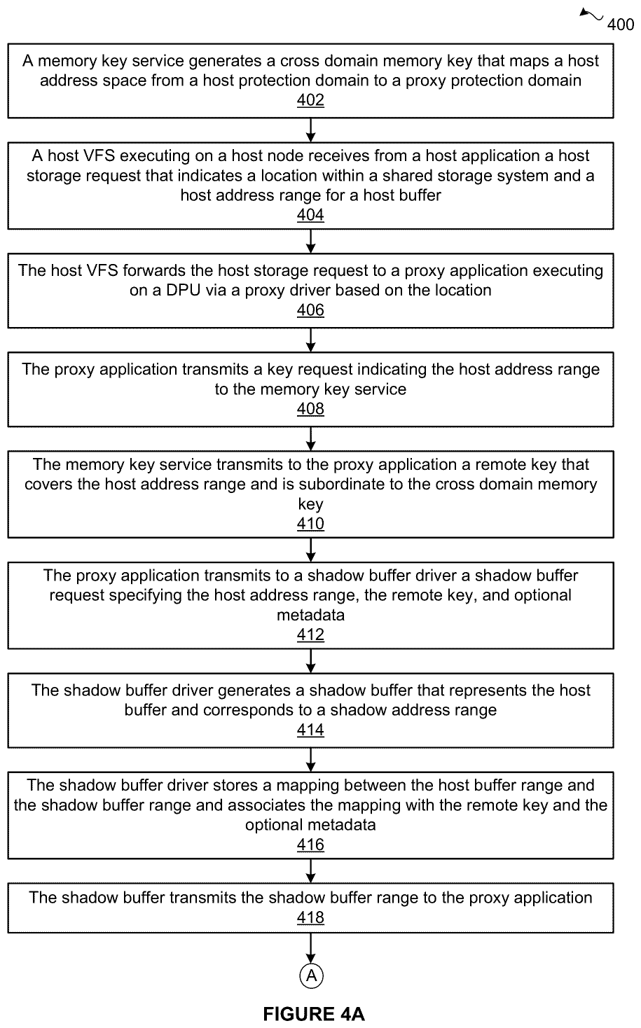

As described in greater detail below in conjunction with FIG. 3B, an address space associated with the host node 110 is also referred to herein as a “host space,” and an address range within the host address space is also referred to herein as a “host address range.” As shown, in some embodiments, the host application 130 includes a host buffer 132 that is allocated for storage of data (e.g., data to be written to or read from the storage system 190) associated with the host storage request 134.

As shown, in some embodiments, the host application 130 issues the host storage request 134 that includes, without limitation, a storage location 136 and a host address range 138. The storage location 136 specifies a location within the shared storage system 190 in any technically feasible fashion. The host address range 138 corresponds to the host buffer 132. The host storage request 134 is a request to transfer data between the host buffer 132 and the storage location 136 within the shared storage system 190.

The host storage request 134 can specify the storage location 136 and the host address range 138 in any technically feasible fashion. For instance, in some embodiments, the storage location 136 is specified via a path name of a file within the shared storage 194 or a file handle for an opened file within the shared storage 194. In the same or other embodiments, the host address range 138 is specified via a base address within the host address space and a size.

As shown, a host VFS 140 and a proxy driver 144 reside in a kernel space 104 within the memory 116 of the host node 110 and execute on the processor 112 of the host node 110. The host VFS 140 is part of an operating system (not shown) associated with the host node 110. The proxy driver 144 is associated with the shared storage system 190.

The host VFS 140 is a VFS that is configured to automatically route the host storage request 134 to the proxy driver 144. The host VFS 140 can be configured to automatically route the host storage request 134 to the proxy driver 144 in any technically feasible fashion. In some embodiments, the host application 130 configures the host VFS 140 to automatically the host storage request 134 to the proxy driver 144 based on the storage location 136.

The proxy driver 144 automatically forwards the host storage request 134 via the host VFS 140 to a proxy application 150 that executes on the DPU 120. The proxy driver 144 and the proxy application 150 can communicate in any technically feasible fashion. For instance, in some embodiments, the proxy driver 144 and the proxy application 150 communicate via one or more queues.

In some embodiments, the proxy driver 144 is a type of kernel module known as “virtiofs” that implements a driver for a virtio-fs device, and a proxy application 150 that executes on the DPU 120 is a type of shared file system daemon known as “virtiofsd” that implements a virtio-fs device for file system sharing. Virtiofs and virtiofsd are part of a shared file system protocol that is designed to to provide local file system semantics between multiple virtual machines sharing a directory tree and is based on a File System in User Space (FUSE) userspace filesystem framework. Techniques for implementing and using virtiofs, virtiosfsd, and FUSE are well-known in the art. Please see https://virtiofs.gitlab.io/, https://virtiofs.gitlab.io/, and https://en.wikipedia.org/wiki/Filesystem_in_Userspace.

In some other embodiments, the proxy driver 144 can forward the host storage request 134 to the proxy application 150 in accordance with FUSE or any other type of userspace filesystem framework and/or in accordance with any other type of shared file system protocol. For instance, in some embodiments, the proxy driver 144 executes in the user space 102 instead of the kernel space 104. In the same or other embodiments, the proxy driver 144 forwards the host storage request 134 from the user space 102 to the proxy application 150 in accordance with a proprietary shared file system protocol, and the proxy application 150 processes the host storage request 134 in accordance with the proprietary shared file system protocol.

As shown, the DPU 120 includes, without limitation, a memory key service 160, a cross domain memory key 162, the proxy application 150, a shadow buffer driver 170, a proxy VFS 180, and a storage driver 184. In some embodiments, the memory key service 160 and the proxy application 150 reside in a user space 106 within the memory 126 of the DPU 120 and execute on the processor 122 of the DPU 120. The shadow buffer driver 170, the proxy VFS 180 and the storage driver 184 reside in a kernel space 108 within the memory 126 of the DPU 120 and execute on the processor 122 of the host node 110. DPU 120. Although not shown, the memory key service 160, the proxy application 150, and the storage driver 184 are linked together and execute in the same process.

The memory key service 160 provides one or more remote keys on-demand, where each remote key enables at least one of remote write access or remote read access for an associated portion of the physical memory. As persons skilled in the art will recognize, to transfer data between a host buffer and a location within the shared storage system 190 via RDMA, the DPU 120 has to expose at least a portion of the physical memory of the host node 110 that corresponds to the host buffer to the shared storage system 190 via a remote key.

As used herein, a “remote key” refers to a memory key that is provided to a remote component (e.g., the file server 192) and grants that remote component permission to access an associated memory region. More generally, permissions to access via RDMA memory regions that are registered to protection domains are granted via memory keys. As persons skilled in the art will recognize, protection domains are collections of RDMA-related resources, where each protection domain is isolated from the other protection domains to provide some level of protection from unauthorized access.

Each memory key indicates an associated memory region that is registered to an associated protection domain and can include any number and/or types of attributes. For example, a memory key can include one or memory access attributes that enable at least one of local read access, local write access, remote write access or remote read access for the associated memory region and the corresponding portion of physical memory. A remote key includes one or more memory access attributes that enable at least one of remote write access or remote read access for the associated memory region.

During an RDMA setup phase order, in order to subsequently provide one or more remote keys, the memory key service 160 generates a host memory key (not shown), a proxy memory key (not shown), and the cross domain memory key 162. Notably, as part of generating any type of memory key, the memory key service 160 registers the memory key with the proxy RDMA interface hardware. As a result, the associated memory region is registered for RDMA access with the proxy RDMA interface hardware via the memory key.

The host memory key embodies access to the host address space corresponding to the physical memory of the host node 110, where the host address space is included in a host protection domain (not shown in FIG. 1) associated with the host node 110. The proxy memory key embodies access to a proxy address space (not shown in FIG. 1) corresponding to the host address space, where the proxy address space is included in a proxy protection domain (not shown in FIG. 1) associated with the DPU 120. The memory key service 160 can generate the host memory key and the proxy memory key in any technically feasible fashion. As persons skilled in the art will recognize, techniques for generating the host memory key and the proxy memory key are well-known in the art.

The memory key service 160 generates the cross domain memory key 162 based on the host memory key and the proxy memory key. As used herein, a “cross domain memory key” is a type of memory key that maps an address space or an address range corresponding to a memory region from one protection domain to another protection domain. An example of a cross domain memory key is a cross guest virtual machine identifier (xgvmi) memory key. In some embodiments, a cross domain memory key includes an attribute that indicates an xgvmi relationship with a different memory key, where the associated memory region is to be interpreted in the context of the different memory key. A cross domain memory key can optionally include any amount and/or types of additional information describing the xgvmi relationship.

More specifically, the cross domain memory key 162 maps the host address space from the host protection domain associated with the host node 110 to the proxy protection domain associated with the DPU 120. The memory key service 160 can generate the cross domain memory key 162 in any technically feasible fashion. In some embodiments, the memory key service 160 adds to the proxy memory key an attribute indicating a xgvmi relationship with the host memory key to generate the cross domain memory key 162.

In operation, the memory key service 160 provides remote keys in response to key requests that include host address ranges. The remote key that is provided in response to a key request specifying a host address range enables at least a host buffer corresponding to the host address range to be remotely accessed via RDMA through the DPU 120.

In some embodiments, the memory key service 160 provides a remote key that is a copy of the cross domain memory key 162 in response to any key request. In that regard, the memory key service 160 two different copies of the cross domain memory key 162 in response to two different memory key requests that include two different host address ranges. As people skilled in the art will recognize, the DPU 120 exposes the entire physical memory of the host node 110 to the shared storage system 190 when invoking each RDMA data transfer between the host node 110 and the shared storage system 190 via a remote key that is a copy of the cross domain memory key 162.

In some other embodiments, the memory key service 160 implements subordinate memory keys in order to reduce the security risks associated with exposing the physical memory of the host node 110. As used herein, a “subordinate memory key” is a memory key that is to be interpreted in the context of a “parent” memory key. A subordinate memory key is referred to herein as “subordinate” to the corresponding parent memory key. A subordinate memory key can be specified in any technically feasible fashion. In some embodiments, a subordinate memory key includes an attribute indicating that the memory key is subordinate to a specified “parent” memory key.

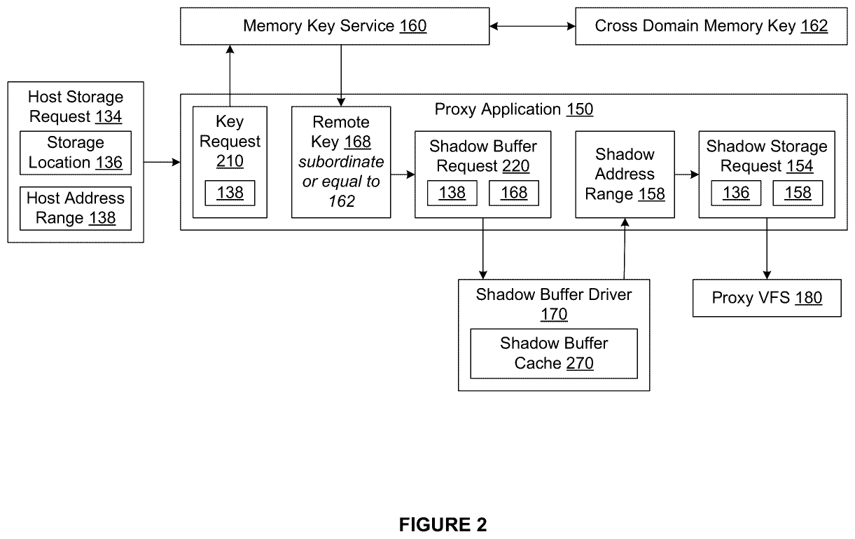

As described in greater detail below in conjunction with FIGS. 2-5, in some embodiments, upon receiving a key request that includes a host address range, the memory key service 160 provides a remote key that is equal to a subordinate memory key corresponding to the host address range. The subordinate memory key and therefore the remote key indicates the host address range and includes an attribute indicating that the subordinate memory key is subordinate to the cross domain memory key 162.

The memory key service 160 can acquire a subordinate memory key corresponding to a host address range in any technically feasible fashion. In some embodiments, the memory key service 160 generates a new subordinate memory key for each key request. In some other embodiments, the memory key service 160 attempts to retrieve from a memory key cache (not shown) a previously generated subordinate memory key that indicates the host address range. If the retrieval attempt is unsuccessful, then the memory key service generates a new subordinate memory key based on the host address range and the cross domain memory key 162 in any technically feasible fashion. The memory key service stores the newly generated subordinate memory key in the subordinate memory key cache based on the host address range.

In this fashion, the memory key service 160 generates and optionally caches any number of subordinate memory keys. Each subordinate memory key indicates a different host address range corresponding to a different host buffer and includes an attribute indicating that the subordinate memory key is subordinate to the cross domain memory key 162.

Advantageously, a subordinate memory key associated with a host buffer exposes the host buffer to the shared storage system 190 without exposing any other portion of the physical memory of the host node 110 to the shared storage system 190. Notably, the use of subordinate memory keys can be implemented separately from or in combination with the use of DPUs to control data transfers between host nodes and shared storage systems 190.

As shown, the proxy application 150 receives the host storage request 134 from the proxy driver 144 and transmits a key request that includes the host address range 138 to the memory key service 160. In response, the memory key service 160 provides to the proxy application 150 a remote key 168. As described previously herein, in some embodiments, the remote key 168 is a copy of the cross domain memory key 162. In some other embodiments, the remote key 168 is a subordinate memory key that indicates the host address range 138 and is subordinate to the cross domain memory key 162. Importantly, the remote key 168 enables at least the host buffer 132 to be remotely accessed via RDMA through the DPU 120.

The proxy application 150 configures the storage driver 184 via the proxy VFS 180 and the shadow buffer driver 170 to invoke an RDMA data transfer operation between the shared storage system 190 and the host node 110 to fulfill the host storage request 134. In general, the proxy VFS 180 can be configured to automatically route requests that are associated with locations within the shared storage system 190 to the storage driver 184 based on the locations. However, as persons skilled in the art will recognize, the proxy VFS 180 is unable to route to the storage driver 184 any request that indicates a host address range within the host address space.

For this reason, to configure the storage driver 184 to fulfill the host storage request 134, the proxy application 150 generates a shadow buffer request (not shown in FIG. 1) that includes the host address range 138, the remote key 168, and optionally any amount and/or types of other metadata that is to be conveyed to the storage driver 184 via the shadow buffer driver 170. The proxy application 150 transmits the shadow buffer request to the shadow buffer driver 170.

Upon receiving the shadow buffer request, the shadow buffer driver 170 generates a shadow buffer (not shown) that represents the host buffer 132. The shadow buffer resides on the DPU 120 and corresponds to a shadow address range 158 within the proxy address space. The shadow buffer driver 170 stores in a shadow buffer cache (not shown in FIG. 1) a mapping between the host address range 138 and the shadow address range 158 and associates the mapping with the remote key 168 and any optional metadata specified in the shadow buffer request. The shadow buffer driver 170 then transmits the shadow address range 158 to the proxy application 150.

The proxy application 150 converts the host storage request 134 to a shadow storage request 154 based on the shadow address range 158. As shown, the shadow storage request 154 includes, without limitation, the storage location 136 and the shadow address range 158. The proxy application 150 transmits the shadow storage request 154 to the proxy VFS 180. The proxy VFS 180 automatically routes the shadow storage request 154 to the storage driver 184 based on the storage location 136.

The storage driver 184 is a version of a driver associated with the file server 192 that is compatible with the processor 122, supports RDMA, and is configured to automatically convert shadow storage requests to corresponding RDMA requests. Upon receiving the shadow storage request 154 from the proxy VFS 180, the storage driver 184 interacts with the shadow buffer driver 170 to map the shadow address range 158 to the host address range 138, the remote key 168, and any optional metadata.

As shown, the storage driver 184 converts the shadow storage request 154 to an RDMA request 186 based on the host address range 138, the remote key, and the optional metadata. The RDMA request 186 includes, without limitation, the storage location 136, the host address range 138, and the remote key 168. Although not shown, the RDMA request 186 can include any amount and/or types of metadata.

As shown, the storage driver 184 transmits the RDMA request 186 to the file server 192 included in the shared storage system 190, thereby invoking an RDMA data transfer operation between the shared storage system 190 and the host node 110 to fulfill the host storage request 134. As referred to herein “invoking” the RDMA data transfer operation between the shared storage system 190 and the host node 110 causes data to be copied from the host buffer 132 to the storage location 136 and/or data to be copied from the storage location 136 to the host buffer 132. Notably, during the RDMA data transfer operation, the shared storage system 190 accesses the host buffer based on the remote key 168.

Advantageously, RDMA data transfer operations are zero-copy techniques that transfer data between the host node 110 and the shared storage system 190 without using any processors, operating systems, or intermediate proxy buffers. In that regard, upon receiving the RDMA request 186, the file server 192 communicates over a network with the proxy RDMA interface to fulfill the RDMA request 186.

In some embodiments, to initiate the RDMA data transfer operation, the file server 192 transmits to the proxy RDMA interface the host address range 138, the remote key 168, any amount of data that is “read” from the shared storage system 190. In response, the proxy RDMA interface interprets the host address range 138 based on the remote key 168.

As described previously herein, the remote key 168 is either equal to the cross domain memory key 162 or is a subordinate memory key that is subordinate to the cross domain memory key 162. Accordingly, the proxy RDMA interface interprets the host address range 138 in the context of the cross domain memory key 162. And because the cross domain memory key 162 indicates an xgvmi relationship with the host memory key, the proxy RDMA interface interprets the host address range 138 in the context of the host memory key. As a result of the interpretation, the proxy RDMA interface is allowed to remotely access the host buffer 132.

To complete the RDMA data transfer operation, the DMA engine included in the DPU 120 transfers data to and/or from the host buffer 132 via DMA. For instance, if the host storage request 134 is a request to read data from the storage location 136, then the DMA engine included in the DPU 120 causes the “read” data received from the shared storage system 190 to be written to the host buffer 132. If, however, the host storage request 134 is a request to write data to the storage location 136, then the DMA engine included in the DPU 120 causes “write” data to be retrieved from the host buffer 132. The proxy RDMA interface transmits the write data to the shared storage system 190, and the shared storage system 190 stores the write data at the storage location 136.

As persons skilled in the art will recognize, the techniques described are illustrative rather than restrictive and can be altered without departing from the broader spirit and scope of the invention. Many modifications and variations on the functionality of the host application 130, the host VFS 140, the proxy driver 144, the memory key service 160, the proxy application 150, the shadow buffer driver 170, the proxy VFS 180, the storage driver 184, and the file server 192 as described herein will be apparent to those of ordinary skill in the art without departing from the scope and spirit of the described embodiments. Further, in various embodiments, any number of the techniques disclosed herein may be implemented while other techniques may be omitted in any technically feasible fashion. Similarly, many modifications and variations on the host storage request 134, key requests, shadow buffer requests, the shadow storage request 154, and the RDMA request 186 will be apparent to those of ordinary skill in the art without departing from the scope and spirit of the described embodiments.

It will be appreciated that the system 100 shown herein is illustrative and that variations and modifications are possible. For example, in some embodiments, any portions (including all) of the functionality provided by the memory key service 160, the proxy application 150, the shadow buffer driver 170, the proxy VFS 180, the storage driver 184, and the file server 192 can be integrated into or distributed across any number of software applications or other software components (including one). Further, the connection topology between the various units in FIG. 1 can be modified as desired.

In some alternate embodiments, the functionality described herein in the context of the DPU 120 can implemented by any other type of computing element that is connected to the host node 110 or any other host node via a shared PCIe bus. A computing element includes, without limitation, any number and/or types of processors and any amount and/or types of memory. As used herein, a “proxy node” and a “proxy computing element” refer to a DPU or any other type of computing element that is connected to any type of host node via a shared PCIe bus.

In some embodiments, the memory key service 160 is implemented as a software service. A software service is also referred to herein as a “service” and “service software.” In some alternate embodiments, any portion (including all or none) of the functionality of the memory key service 160 as described herein can be implemented via one or more services in any technically feasible fashion.

### Implementing Zero Copy RDMA Operations Through a DPU

FIG. 2 is a more detailed illustration of the proxy application 150 of FIG. 1, according to various embodiments. For explanatory purposes, the functionality of the proxy application 150 is described in FIG. 2 in the context of invoking an RDMA data transfer operation between the host node 110 and the shared storage system 190 through the DPU 120 in accordance with the host storage request 134.

As described previously herein in conjunction with FIG. 1, the host storage request 134 includes, without limitation, the storage location 136 and the host address range 138. Referring back to FIG. 1, the storage location 136 specifies a location within the shared storage 194, and the host address range 138 corresponds to the host buffer 132 included in the host application 130. As described in greater detail below in conjunction with FIG. 3, the host address range 138 is within a host protection domain (not shown) associated with the host node 110.

As described previously herein in conjunction with FIG. 1, in some embodiments, the proxy application 150 receives the host storage request 134 from the proxy driver 144. Upon receiving the host storage request 134, the proxy application 150 generates a key request 210 that includes the host address range 138. The proxy application 150 transmits the key request 210 to the memory key service 160.

In response, the memory key service 160 transmits the remote key 168 to the proxy application 150. As described previously herein in conjunction with FIG. 1, the remote key 168 enables at least the host buffer 132 to be remotely accessed via RDMA through the DPU 120. If the memory key service 160 implements subordinate memory keys, then the remote key 168 is equal to a subordinate memory key that indicates the host address range 138 and is subordinate to the cross domain memory key 162. Otherwise, the remote key 168 is equal to the cross domain memory key 162. The memory key service 160 is described in greater detail below in conjunction with FIG. 3A.

In some alternate embodiments, the memory key service 160 does not implement subordinate memory keys, the key request 210 can omit the host address range 138, and the memory key service 160 sets the remote key 168 equal to the cross domain memory key 162. In yet other embodiments, the memory key service 160 is omitted from the system 100, the proxy application 150 generates the cross domain memory key 162, and the proxy application 150 sets the remote key 168 equal to the cross domain memory key 162 irrespective of the host address range 138.

The memory key service 160 generates a shadow buffer request 220 based on the host storage request 134, the remote key 168, and optionally any amount and/or types of other metadata that is to be conveyed to the storage driver 184 via the shadow buffer driver 170. The memory key service 160 transmits the shadow buffer request 220 to the shadow buffer driver 170.

As shown, in some embodiments, the shadow buffer driver 170 includes, without limitation a shadow buffer cache 270. In some alternate embodiments, the shadow buffer cache 270 is external to but accessible to the shadow buffer driver 170. Upon receiving the shadow buffer request 220, the shadow buffer driver 170 generates a shadow buffer (not shown) that represents the host buffer 132. As described previously herein in conjunction with FIG. 1, the shadow buffer resides on the DPU 120 and corresponds to the shadow address range 158 within the proxy address space.

The shadow buffer driver 170 stores in the shadow buffer cache 270 a mapping between the host address range 138 and the shadow address range 158 and associates the mapping with the remote key 168 and any optional metadata specified in the shadow buffer request 220. The shadow buffer driver 170 then transmits the shadow address range 158 to the proxy application 150.

The proxy application 150 converts the host storage request 134 to the shadow storage request 154 based on the shadow address range 158. As shown, the shadow storage request 154 includes, without limitation, the storage location 136 and the shadow address range 158. The proxy application 150 transmits the shadow storage request 154 to the proxy VFS 180.

Referring back to FIG. 1, the proxy VFS 180 automatically routes the shadow storage request 154 to the storage driver 184 based on the storage location 136. As described previously herein in conjunction with FIG. 1, the storage driver 184 interacts with the shadow buffer driver 170 to retrieve from the shadow buffer cache 270 the host address range 138, the remote key 168, and any optional metadata based on the shadow address range 158.

### Generating Subordinate Memory Keys Using a DPU

FIG. 3A is a more detailed illustration of the memory key service 160 of FIG. 1, according to various embodiments. In embodiments depicted in FIGS. 3A, the memory key service 160 provides subordinate memory keys to reduce security risks when implementing RDMA through DPUs.

As described previously herein in conjunction with FIG. 1, during an RDMA setup phase order, the memory key service 160 generates a host memory key (not shown), a proxy memory key (not shown), and the cross domain memory key 162. As part of generating any memory key (including the host memory key, the proxy memory, the cross domain memory key 162, and each of any number of subordinate memory keys), the memory key service 160 registers the memory key with the proxy RDMA interface hardware (not shown in FIG. 3A).

As shown, the memory key service 160 includes, without limitation, an initialization engine 310, a key lookup engine 320, a subordinate memory key cache 330, and a subordinate key generation engine 350. During an RDMA setup phase order, in order to subsequently provide one or more remote keys, the initialization engine 310 generates a host memory key (not shown), a proxy memory key (not shown), and the cross domain memory key 162. Notably, as part of generating any type of memory key, the initialization engine 310 registers the memory key with the proxy RDMA interface hardware. As a result, the memory region associated with the memory key is registered for RDMA access with the proxy RDMA interface hardware via the memory key.

The host memory key embodies access to a host address space 380 corresponding to the physical memory of the host node 110, where the host address space 380 is included in a host protection domain 370 associated with the host node 110. The proxy memory key embodies access to a proxy address space (not shown) corresponding to the host address space 380, where the proxy address space is included in a proxy protection domain 390 associated with the DPU 120. The initialization engine 310 can generate the host memory key and the proxy memory key in any technically feasible fashion.

The initialization engine 310 generates the cross domain memory key 162 based on the host memory key and the proxy memory key. The cross domain memory key 162 maps the host address space 380 from the host protection domain 370 to the proxy protection domain 390. In some embodiments, the cross domain memory key 162 is a cross guest virtual machine identifier (xgvmi) memory key that indicates the host address space 380 and includes an attribute that indicates an xgvmi relationship with the host memory key.

The initialization engine 310 can generate the cross domain memory key 162 in any technically feasible fashion. In some embodiments, the initialization engine 310 adds to the proxy memory key an attribute indicating a xgvmi relationship with the host memory key to generate the cross domain memory key 162.

Subsequently, the memory key service 160 provides remote keys in response to key requests that include host address ranges. The remote key that is provided in response to a key request specifying a host address range enables at least a host buffer corresponding to the host address range to be remotely accessed via RDMA through the DPU 120.

For explanatory purposes, FIG. 3A depicts a series of circles numbered 1-6 that correspond to a sequence of exemplary events associated with responding to the key request 210 that includes the host address range 138. Referring back to FIG. 1, the host address range 138 corresponds to the host buffer 132.

Prior to receiving the key request 210, the memory key service 160 generates and stores in the subordinate memory key cache 330, a subordinate memory key 340(1)—a subordinate memory key 340(N−1), where N can be any integer greater than 2. The subordinate memory key 340(1)—a subordinate memory key 340(N−1) indicate, respectively, a host address range 382(1)—a host address range 382(N−1) and a subordinate relationship to the cross domain memory key 162.

As depicted with a circle numbered 1, the memory key service 160 receives from the proxy application 150 the key request 210 that includes the host address range 138. As depicted with a circle numbered 2, the key lookup engine 320 attempts to retrieve from the subordinate memory key cache 330 a previously generated subordinate memory key that indicates the host address range 138. As depicted with a circle numbered 3, the key lookup engine 320 fails to retrieve from the subordinate memory key cache 330 a previously generated subordinate memory key that indicates the host address range 138 and therefore forwards the key request 210 to the subordinate key generation engine 350.

As depicted with a circle numbered 4, the subordinate key generation engine 350 generates the subordinate memory key 340(N) based on the host address range 138 and the cross domain memory key 162. The subordinate memory key 340(N) indicates the host address range 138 and includes an attribute indicating that the subordinate memory key 340(N) is subordinate to the cross domain memory key 162.

As depicted with a circle numbered 5, the subordinate key generation engine 350 stores the subordinate memory key 340(N) in the subordinate memory key cache 330 based on the host address range 138. As indicated in italics, the subordinate memory key 340(N) corresponds to the host buffer 132. As depicted with a circle numbered 6, the subordinate key generation engine 350 sets the remote key 168 equal to the subordinate memory key 340(N) and transmits the remote key 168 to the proxy application 150.

As depicted with a dashed line, if the memory key service 160 subsequently receives from the proxy application 150 a new key request that includes the host address range 138, then the key lookup engine 320 retrieves the subordinate memory key 340(N) from the subordinate memory key cache 330 based on the host address range 138. The key lookup engine 320 sets a new remote key equal to the retrieved subordinate memory key 340(N) and then transmits the new remote key to the proxy application 150.

Importantly, each of the subordinate memory key 340(1)—a subordinate memory key 340(N) enables a different host buffer to be remotely accessed via RDMA through the DPU 120. In particular, the subordinate memory key 340(N) enables the host buffer 132 to be remotely accessed via RDMA through the DPU 120.

FIG. 3B is a conceptual illustration of protection domain mappings 360 implemented by the memory key service 160 of FIG. 3A, according to various embodiments. Each of the protection domain mappings 360 maps a different address range that lies within the host address space 380 and has been configured for RDMA access from the host protection domain 370 to the proxy protection domain 390.

Referring back to FIG. 1, the host protection domain 370 is associated with the host node 110, and the proxy protection domain 390 is associated with the DPU 120. More specifically, the proxy protection domain 390 is associated with a connection to the file server 192, where the connection is implemented via the storage driver 184. The storage driver 184 causes data to be transferred between the shared storage 194 and the host node 110 via RDMA data transfer operations in accordance with access granted via memory keys.

As shown, in some embodiments, the cross domain memory key 162 maps the host address space 380 from the host protection domain 370 to the proxy protection domain 390. The subordinate memory key 340(1)—the subordinate memory key 340(N−1) indicate, respectively, the host address range 382(1)—the host address range 382(N−1) and a subordinate relationship to the cross domain memory key 162. The subordinate memory key 340(N) indicates the host address range 138 and a subordinate relationship to the cross domain memory key 162.

As described previously herein, the subordinate memory key 340(1)—the subordinate memory key 340(N) are interpreted in the context of the cross domain memory key 162. Consequently, as shown, the subordinate memory key 340(1)—the subordinate memory key 340(N−1) map via the cross domain memory key 162, respectively, the host address range 382(1)—the host address range 382(N−1) from the host protection domain 370 to the proxy protection domain 390. And the subordinate memory key 340(N) maps via the cross domain memory key 162 the host address range 138 from the host protection domain 370 to the proxy protection domain 390.

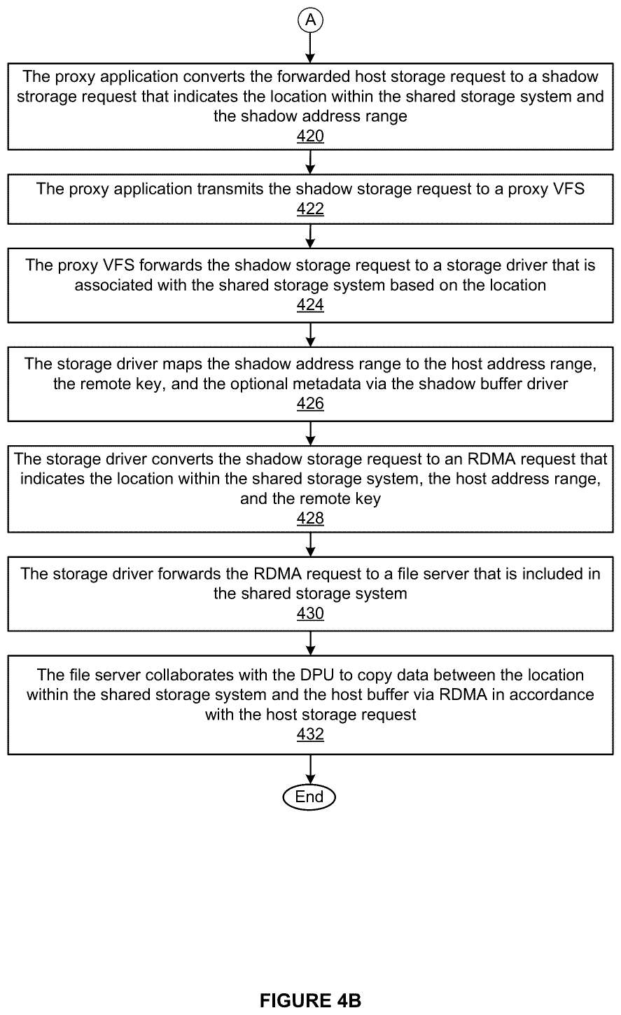

FIGS. 4A-4B set forth a flow diagram of method steps for processing a request to access one or more locations within a shared storage system, according to various embodiments. Although the method steps are described with reference to the systems of FIGS. 1 and 2, persons skilled in the art will understand that any system configured to implement the method steps, in any order, falls within the scope of the embodiments.

As shown, a method 400 begins at step 402, where the memory key service 160 generates the cross domain memory key 162 that maps a host address space from a host protection domain to a proxy protection domain. At step 404, the host VFS 140 executing on the host node 110 receives from the host application 130 a host storage request that indicates a location within shared storage system 190 and a host address range for a host buffer. At step 406, the host VFS 140 forwards the host storage request to the proxy application 150 executing on the DPU 120 via the proxy driver 144 based on the location.

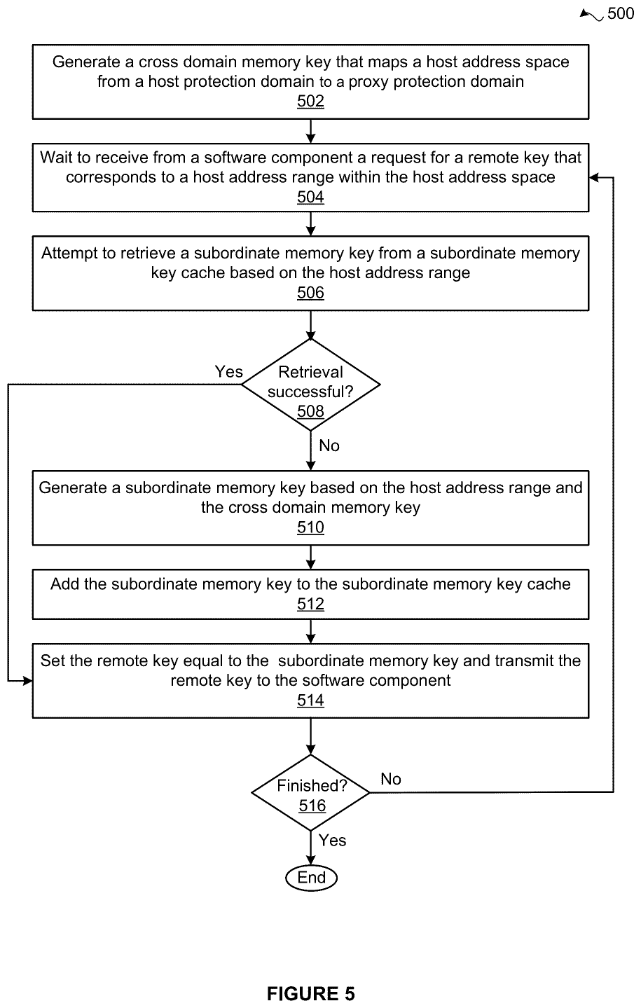

At step 408, the proxy application 150 transmits a key request indicating the host address range to the memory key service 160. At step 410, the memory key service 160 transmits to the proxy application 150 a remote key that covers the host address range and is subordinate to the cross domain memory key 162. The memory key service 160 can determine the remote key in any technically feasible fashion. For instance, in some embodiments, the memory key service 160 implements the method steps described in FIG. 5 below to determine the remote key based on the host address range and the cross domain memory key 162.

At step 412, the proxy application 150 transmits to shadow buffer driver 170 a shadow buffer request specifying the host address range, the remote key, and optional metadata. At step 414, the shadow buffer driver 170 generates a shadow buffer that represents the host buffer and corresponds to a shadow address range. At step 416, the shadow buffer driver 170 stores a mapping between the host buffer range and the shadow buffer range and associates the mapping with the remote key and the optional metadata. At step 418, the shadow buffer driver 170 transmits the shadow buffer range to the proxy application 150.

At step 420, the proxy application 150 converts the forwarded host storage request to a shadow storage request that indicates the location within the shared storage system 190 and the shadow address range. At step 422, the proxy application 150 transmits the shadow storage request to the proxy VFS 180. At step 424, the proxy VFS 180 forwards the shadow storage request to the storage driver 184 that is associated with the shared storage system 190 based on the location.

At step 426, the storage driver 184 maps the shadow address range to the host address range, the remote key, and the optional metadata via the shadow buffer driver 170. At step 428, the storage driver 184 converts the shadow storage request to an RDMA request that indicates the location within the shared storage system 190, the host address range, and the remote key.

At step 430, the storage driver 184 forwards the RDMA request to file server 192 that is included in the shared storage system 190. At step 432, the file server 192 collaborates with the DPU 120 to copy data between the location and the host buffer in accordance with the RDMA request. The method 400 then terminates.

Note that, as described previously herein, in some embodiments, the remote key is equal to the cross domain memory key 162 and therefore the entire host address space is exposed to the shared storage system 190. In the same or other embodiments, the proxy application 150 directly performs step 402 and steps 408 and 410 are omitted from the method 400.

FIG. 5 is a flow diagram of method steps for implementing subordinate memory keys that expose different subsets of a physical memory, according to various embodiments. Although the method steps are described with reference to the systems of FIGS. 1-3B, persons skilled in the art will understand that any system configured to implement the method steps, in any order, falls within the scope of the embodiments.

As shown, a method 500 begins at step 502, where the memory key service 160 generates the cross domain memory key 162 that maps the host address space 380 from host protection domain 370 to proxy protection domain 390. At step 504, the memory key service 160 waits to receive from a software component a request for a remote key that corresponds to a host address range within the host address space 380.

As described previously herein, in some embodiments, the host address range 382(1)—the host address range 382(N−1) and the host address range 138 are examples of host address ranges within the host address space 380. In some embodiments, the software component is a software application (e.g., the proxy application 150) that resides in a user space on a proxy node. In some other embodiments, the software component is a driver that resides in a kernel space on a proxy node.

At step 506, the memory key service 160 attempts to retrieve a subordinate memory key from subordinate memory key cache 330 based on the client address range. At step 508, the memory key service 160 determines whether the retrieval of the subordinate memory key was successful. If, at step 508, the memory key service 160 determines that the retrieval of the subordinate memory key was successful, then the method 500 proceeds directly to step 514.

If, however, at step 508, the memory key service 160 determines that the retrieval of the subordinate memory key was not successful, then the method 500 proceeds to step 510. At step 510, the memory key service 160 generates a subordinate memory key based on the client address range and the cross domain memory key 162. At step 512, the memory key service 160 adds the subordinate memory key to the subordinate memory key cache 330.

At step 514, the memory key service 160 sets a remote key equal to the subordinate memory key and transmits the remote key to the software component. At step 516, the memory key service 160 determines whether the memory key service 160 has finished receiving requests for remote keys that correspond to host address ranges within the host address space 380.

If, at step 516, the memory key service 160 determines that the memory key service 160 has not finished receiving requests for remote keys that correspond to host address ranges within the host address space 380, then the method 500 returns to step 504. At step 504, the memory key service 160 waits to receive from a software component a new request for a remote key that corresponds to a host address range within the host address space 380.

If, however, at step 516, the memory key service 160 determines that the memory key service 160 has finished receiving requests for remote keys that correspond to host address ranges within the host address space 380, then the method 500 terminates.

In sum, the disclosed techniques can be used to implement RDMA through a DPU. In some embodiments, a DPU 120 is connected to a host node via PCIe and to a shared storage system via a network. The shared storage system includes any amount and/or types of shared storage and a file server that controls access to the shared storage. A host application executes in the user space of the host node. A host VFS and a proxy driver execute in the kernel space of the host node. A proxy application and a memory key service execute in the user space of the DPU. A shadow buffer driver, a proxy VFS, and a storage driver execute in the kernel space of the DPU. During an RDMA setup phase, the memory key application generates a cross domain memory key that maps a host address space from a host protection domain associated with the host node to a proxy protection domain associated with the DPU.

The host application issues a request to transfer data between a host buffer included in the host application and a location within the shared storage system. The request includes, without limitation, a host address range corresponding to the host buffer and the location. The host VFS automatically routes the request to the proxy driver based on the location. The proxy driver forwards the request to the proxy application. The proxy application transmits a key request indicating the host address range to the memory key application.

The memory key application attempts to retrieve a subordinate memory key from a subordinate memory key cache based on the host address range. If the retrieval is successful, then the memory key application transmits to the proxy application a remote key that is equal to the retrieved subordinate memory key. Otherwise, the memory key application generates a new subordinate memory key that indicates the host address range and is subordinate to the cross domain memory key. The memory key application adds the new subordinate memory key to the subordinate memory key cache based on the host address range. The memory key application transmits to the proxy application a remote key that is equal to the new subordinate memory key.

The proxy application transmits to the shadow buffer driver a shadow buffer request specifying the host address range, the remote key, and any amount and/or types of optional metadata. The shadow buffer driver generates a shadow buffer that represents the host buffer and corresponds to a shadow address range. The shadow buffer driver stores in a shadow buffer cache a mapping between the host buffer range and the shadow buffer range and associates the mapping with the remote key and the optional metadata. The shadow buffer driver transmits the shadow buffer range to the proxy application.

The proxy application converts the request to a shadow storage request that indicates the location and the shadow address range. The proxy application transmits the shadow storage request to the proxy VFS. The proxy VFS forwards the shadow storage request to the storage driver based on the location. The storage driver maps the shadow address range to the host address range, the remote key, and the optional metadata via the shadow buffer driver. The storage driver converts the shadow storage request to an RDMA request that indicates the location within the shared storage system, the host address range, and the remote key. The storage driver transmits the RDMA request to the file server. The file server collaborates with RDMA network interface hardware included in the DPU to copy data between the location within the shared storage system and the host buffer via RDMA in accordance with the RDMA request.

At least one technical advantage of the disclosed techniques relative to the prior art is that, with the disclosed techniques, a DPU can invoke remote direct memory access (RDMA) operations between a host node and a shared storage system. These RDMA operations enable a DPU to cause data to be transferred between host buffer(s) residing on the host node and location(s) within a shared storage system without using intermediate proxy buffers. Accordingly, with the disclosed techniques, data transfer latencies can be decreased and overall data throughput can be increased, which can improve data transfer performance relative to what can be achieved using prior art techniques. Furthermore, unlike prior art techniques, the disclosed techniques do not incur overhead associated with executing additional copy operations to and from proxy buffers. Accordingly, the amount of processing resources required to transfer data between host nodes and shared storage systems can be decreased, which can increase the overall performance of the software applications executing on host nodes relative to what can be achieved using prior art techniques. These technical advantages provide one or more technological improvements over prior art approaches.

In addition, to invoke RDMA operations between a host node and a shared storage system, a DPU has to expose the physical memory of the host node to the shared storage system. However, the disclosed techniques also enable a DPU to implement subordinate memory keys in order to reduce the security risks associated with exposing the physical memory of the host node. In that regard, when issuing an RDMA request to a shared storage system on behalf of a host node, the DPU is able to provide a subordinate memory key that is associated with a host buffer within the physical memory of the host node. The subordinate memory key exposes the host buffer to the shared storage system without exposing any other portion of the physical memory of the host node to the shared storage system. Notably, the use of subordinate memory keys can be implemented separately from or in combination with the use of DPUs to control data transfers between host nodes and shared storage systems. These additional technical advantages provide one or more additional technological improvements over prior art approaches.

1. In some embodiments, a computer-implemented method for remotely accessing one or more portions of a physical memory included in a host node comprises generating a first memory key that maps a host address space from a first protection domain associated with the host node to a second protection domain associated with a proxy node; generating a second memory key based on the first memory key and a first address range associated with the host node; and transmitting the second memory key to a software component executing on the proxy node, wherein the software component causes a shared storage system to access a first portion of the physical memory based on the second memory key.

2. The computer-implemented method of clause 1, further comprising generating a third memory key based on the first memory key and a second address range associated with the host node; and transmitting the third memory key to the software component, wherein the software component causes the shared storage system to access a second portion of the physical memory based on the third memory key.

3. The computer-implemented method of clauses 1 or 2, wherein the first portion of the physical memory comprises a first host buffer that corresponds to the first address range.

4. The computer-implemented method of any of clauses 1-3, wherein the first memory key comprises a cross guest virtual machine identifier memory key.

5. The computer-implemented method of any of clauses 1-4, further comprising storing the second memory key in a memory key cache based on the first address range prior to transmitting the second memory key to the software component.

6. The computer-implemented method of any of clauses 1-5, further comprising failing to retrieve the second memory key from a memory key cache based on the first address range prior to generating the second memory key.

7. The computer-implemented method of any of clauses 1-6, wherein the software component causes the shared storage system to access the first portion of the physical memory by causing a storage driver executing on the proxy node to transmit to the shared storage system a remote direct memory access request that specifies the first address range and the second memory key.

8. The computer-implemented method of any of clauses 1-7, wherein the software component comprises a software application that resides in a user space.

9. The computer-implemented method of any of clauses 1-8, wherein the second memory key includes one or more memory access attributes that enable at least one of remote write access or remote read access for the first portion of the physical memory.

10. The computer-implemented method of any of clauses 1-9, wherein the shared storage system comprises at least one of shared file storage, shared block storage, or object storage.

11. The computer-implemented method of any of clauses 1-10, wherein at least the generating the second memory key is implemented via a service.

12. In some embodiments, one or more non-transitory computer readable media include instructions that, when executed by one or more processors, cause the one or more processors to remotely access one or more portions of a physical memory included in a host node by performing the steps of generating a first memory key that maps a host address space from a first protection domain associated with the host node to a second protection domain associated with a data processing unit (DPU); generating a second memory key based on the first memory key and a first address range associated with the host node; and transmitting the second memory key to a software component executing on the DPU, wherein the software component causes a shared storage system to access a first portion of the physical memory based on the second memory key.

13. The one or more non-transitory computer readable media of clause 12, further comprising generating a third memory key based on the first memory key and one or more address ranges associated with the host node and transmitting the third memory key to the software component, wherein the software component causes the shared storage system to access the one or more portions of the physical memory based on the third memory key.

14. The one or more non-transitory computer readable media of clauses 12 or 13, wherein the second memory key comprises a remote key that is subordinate to the first memory key.

15. The one or more non-transitory computer readable media of any of clauses 12-14, wherein the first memory key comprises a cross guest virtual machine identifier memory key.

16. The one or more non-transitory computer readable media of any of clauses 12-15, further comprising storing the second memory key in a memory key cache based on the first address range prior to transmitting the second memory key to the software component.

17. The one or more non-transitory computer readable media of any of clauses 12-16, further comprising failing to retrieve the second memory key from a memory key cache based on the first address range prior to generating the second memory key.

18. The one or more non-transitory computer readable media of any of clauses 12-17, wherein the software component causes the shared storage system to access the first portion of the physical memory by causing a remote direct memory access data transfer operation to be invoked between the shared storage system and the host node.

19. The one or more non-transitory computer readable media of any of clauses 12-18, wherein the software component comprises a software application that resides in a user space.

20. The one or more non-transitory computer readable media of any of clauses 12-19, wherein the second memory key includes an attribute indicating that the second memory key is subordinate to the first memory key.

21. In some embodiments, a system comprises one or more memories storing instructions and one or more processors coupled to the one or more memories that, when executing the instructions, perform the steps of generating a first memory key that maps a host address space from a first protection domain associated with a host node to a second protection domain associated with a data processing unit (DPU); generating a second memory key based on the first memory key and a first address range associated with the host node; and transmitting the second memory key to a software component executing on the DPU, wherein the software component causes a shared storage system to access a first portion of a physical memory included in the host node based on the second memory key.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for remotely accessing one or more portions of a physical memory included in a host node, the method comprising:
generating a first memory key that maps a host address space from a first protection domain associated with the host node to a second protection domain associated with a proxy node;
generating a second memory key based on the first memory key and a first address range associated with the host node; and
transmitting the second memory key to a software component executing on the proxy node, wherein the software component causes a shared storage system to access a first portion of the physical memory based on the second memory key.

2. The computer-implemented method of claim 1, further comprising:
generating a third memory key based on the first memory key and a second address range associated with the host node; and
transmitting the third memory key to the software component, wherein the software component causes the shared storage system to access a second portion of the physical memory based on the third memory key.

3. The computer-implemented method of claim 1, wherein the first portion of the physical memory comprises a first host buffer that corresponds to the first address range.

4. The computer-implemented method of claim 1, wherein the first memory key comprises a cross guest virtual machine identifier memory key.

5. The computer-implemented method of claim 1, further comprising storing the second memory key in a memory key cache based on the first address range prior to transmitting the second memory key to the software component.

6. The computer-implemented method of claim 1, further comprising failing to retrieve the second memory key from a memory key cache based on the first address range prior to generating the second memory key.

7. The computer-implemented method of claim 1, wherein the software component causes the shared storage system to access the first portion of the physical memory by causing a storage driver executing on the proxy node to transmit to the shared storage system a remote direct memory access request that specifies the first address range and the second memory key.

8. The computer-implemented method of claim 1, wherein the software component comprises a software application that resides in a user space.

9. The computer-implemented method of claim 1, wherein the second memory key includes one or more memory access attributes that enable at least one of remote write access or remote read access for the first portion of the physical memory.

10. The computer-implemented method of claim 1, wherein the shared storage system comprises at least one of shared file storage, shared block storage, or object storage.

11. The computer-implemented method of claim 1, wherein at least the generating the second memory key is implemented via a service.

12. One or more non-transitory computer readable media including instructions that, when executed by one or more processors, cause the one or more processors to remotely access one or more portions of a physical memory included in a host node by performing the steps of:
generating a first memory key that maps a host address space from a first protection domain associated with the host node to a second protection domain associated with a data processing unit (DPU);
generating a second memory key based on the first memory key and a first address range associated with the host node; and
transmitting the second memory key to a software component executing on the DPU, wherein the software component causes a shared storage system to access a first portion of the physical memory based on the second memory key.

13. The one or more non-transitory computer readable media of claim 12, further comprising:
generating a third memory key based on the first memory key and one or more address ranges associated with the host node; and
transmitting the third memory key to the software component, wherein the software component causes the shared storage system to access the one or more portions of the physical memory based on the third memory key.

14. The one or more non-transitory computer readable media of claim 12, wherein the second memory key comprises a remote key that is subordinate to the first memory key.

15. The one or more non-transitory computer readable media of claim 12, wherein the first memory key comprises a cross guest virtual machine identifier memory key.

16. The one or more non-transitory computer readable media of claim 12, further comprising storing the second memory key in a memory key cache based on the first address range prior to transmitting the second memory key to the software component.

17. The one or more non-transitory computer readable media of claim 12, further comprising failing to retrieve the second memory key from a memory key cache based on the first address range prior to generating the second memory key.

18. The one or more non-transitory computer readable media of claim 12, wherein the software component causes the shared storage system to access the first portion of the physical memory by causing a remote direct memory access data transfer operation to be invoked between the shared storage system and the host node.

19. The one or more non-transitory computer readable media of claim 12, wherein the software component comprises a software application that resides in a user space.

20. The one or more non-transitory computer readable media of claim 12, wherein the second memory key includes an attribute indicating that the second memory key is subordinate to the first memory key.

21. A system comprising:
one or more memories storing instructions; and
one or more processors coupled to the one or more memories that, when executing the instructions, perform the steps of:
generating a first memory key that maps a host address space from a first protection domain associated with a host node to a second protection domain associated with a data processing unit (DPU);
generating a second memory key based on the first memory key and a first address range associated with the host node; and
transmitting the second memory key to a software component executing on the DPU, wherein the software component causes a shared storage system to access a first portion of a physical memory included in the host node based on the second memory key.
